(19) United States
(12) Patent Application Publication
(10) Pub. No.: US 2022/0363847 A1
(43) Pub. Date: Nov. 17, 2022

(54) ORIENTED FILM OF BINARY POLYMER COMPOSITION

(71) Applicant: WOODLY OY, Helsinki (FI)

(72) Inventors: Martta ASIKAINEN, Helsinki (FI); Upi ANTTILA, Helsinki (FI); Jaakko KAMINEN, Helsinki (FI); Tommi VUORINEN, Tampere (FI); Hannu MINKKINEN, Tampere (FI); Tero MALM, Tampere (FI); Teijo ROKKONEN, Tampere (FI); Timo FLYKTMAN, Tampere (FI)

(73) Assignee: WOODLY OY, Helsinki (FI)

(21) Appl. No.: 17/770,949

(22) PCT Filed: Oct. 21, 2020
(86) PCT No.: PCT/FI2020/050690

§ 371 Date: Apr. 21, 2022

(30) Foreign Application Priority Data
Oct. 22, 2019 (FI) 20195903

(51) Int. Cl. C08J 5/18; B29C 48/00; B29C 55/06; C08L 1/14; C08L 67/02

(52) U.S. Cl. CPC C08J 5/18; B29C 48/0018; B29C 55/06; C08L 1/14; C08L 67/02; B29K 2001/12

(57) ABSTRACT

The invention concerns a film based on a binary polymer composition having at least a first polymer and a second polymer. The film is oriented by extruding and stretching the film in at least the machine direction. The glass-transition temperature (Tg) of the first polymer is greater than the orientation temperature and the glass-transition temperature (Tg) of the second polymer is lower than the orientation temperature. Furthermore, a method and use related thereto are described.

### TECHNICAL FIELD

The present disclosure relates to polymer films. Especially, to a film based on a binary polymer composition comprising at least a first polymer and a second polymer, which film is oriented by extruding and stretching the film in at least machine direction.

### BACKGROUND

Various kinds of polymer-based films are used for packaging solutions and other application, where a product or article needs packing, covering or protec-tion. The films may be processed in different ways to obtain the desired properties depending on the intended end use.

A polymer-based film, such as a cast film, may be stretched either in a longitudinal direction, or machine direction (MD) and/or transverse direction (TD) to attain desired film properties, which differ from the properites of a non-streched film.

Mono-axial oriented film is mostly used for shrink labels and sleeves, where it may replace paper and adhesive labels.

Longitudinal direction orientation of the film is achieved by increasing the speeds between a group of rollers. Transverse direction orientation on the other hand is achieved by a chain track system where clips fix the cast film during the stretching process.

Various steching methods and levels are used to obtain desired features of the polymer-based film.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject-matter.

The invention concerns a film based on a binary polymer composition comprising at least a first polymer and a second polymer, wherein the film is oriented by extruding and stretching the film in at least machine direction (MD), and wherein the glass-transition temperature (Tg) of the first polymer is greater than the orientation temperature and the glass-transition temperature (Tg) of the second polymer is lower than the orientation temperature.

Furter, the invention relates to a package comprising the film based on a binary polymer composition.

The invention also relates to a method for manufacturing a film based on a binary polymer composition, which method comprises the following steps:
obtaining a homogenous polymer blend of a binary polymer composition comprising at least a first polymer and a second polymer,
forming the homogenous polymer blend into a film, and
orientating the film by extruding and stretching the film in at least machine direction MD), and the glass-transition temperature (Tg) of the first polymer is greater than the orientation temperature and the glass-transition temperature (Tg) of the second polymer is lower than the orientation temperature.

Furthermore, the invention relates to use of the film based on a binary polymer composition comprising at least a first polymer and a second polymer in the manufacture of a packaging material. The packaging material may be selected from for example cling film, shrink film, stretch film, bag film or container liners, films meant for consumer packaging (e.g. packaging film for frozen products, shrink film for transport packaging, food wrap film, packaging bags, or form, fill and seal packaging film), laminating film (e.g. laminating of aluminum or paper used for packaging for example milk or coffee), multilayer film, barrier film (e.g. film acting as an aroma or oxygen barrier used for packaging food, e.g. cold meats and cheese), films for the packaging of medical products, agricultural film (e.g. greenhouse film, crop forcing film, silage film, silage stretch film), extrusion coating applications, bag, box, container, tray, casing, housing or molded 3D-objects, and/or other applications in packaging goods, such as food, medical products or cosmetics.

### BRIEF DESCRIPTION OF THE DRAWINGS

The accompanying drawings, which are included to provide a further understanding of the embodiments and constitute a part of this specification, illustrate various embodiments. In the drawings:

FIG. 1 illustrates Example 3, Film 3 tear test with test sample cut to Transverse Direction (TD).

FIG. 2 illustrates Example 3, Film 3 tear test with test sample cut to Machine Direction (MD).

FIG. 3 illustrates Example 5, Scanning electron microscopy of film with orientation degree of 1.0, CAP 72.5% and PBS 27.5% (reference example).

FIG. 4 illustrates Example 5, Scanning electron microscopy of film with orientation degree of 1.5, CAP 72.5% and PBS 27.5%.

FIG. 5 illustrates Example 5, Scanning electron microscopy of film with orientation degree of 1.9, CAP 72.5% and PBS 27.5%.

### DETAILED DESCRIPTION

The present invention is based on the finding that new interesting features can be achieved by orienting a film based on a binary polymer composition. Especially, in connection with the present invention it was noticed that the tearability of the film behaves in a different way than known oriented films. The provided tearablity can help to solve problems related to various packaging solutions, such as making it easier for consumers to open the package properly without harming the product. Furthermore, the package can be opened without tools, such as scissors. Injuries caused by difficulties to open a package can also be reduced.

To achieve the desired effect, it is essential that the film comprises at least two polymers, a first polymer and a second polymer (a “binary polymer composition” or “binary polymer blend”). According to one embodiment of the present invention, the binary polymer composition comprises only two polymers, and optionally additives. The polymers need to have different Tg (glass transition) temperatures.

The films and materials based on this invention can be particulary suitable for replacing packaging films and materials made of PET (polyethylene terephthalate). PET is very often used as the material in blister packaging, clamshell packaging, modified atmosphere packaging, rigid packaging, boxes, heat sealed packaging etc. PET is well suited to these applications due to its clarity and thermoforming properties. However, packaging made from PET is difficult to open. PET packaging does not tear open even when a notch is made to the packaging. Sharp tools, such as scissors, knife, cutter or a blade is needed for the opening of PET packaging. This may result in personal injuries or the damaging of the packed product.

Also, PET packaging has relatively high carbon footprint and these types of packagings are not environmentally friendly. Typically, PET is mostly made from fossil resources. It is very difficult to make PET products more sustainable.

This invention describes a film material which may replace for example PET in different types of packaging applications. PET materials were used as reference examples in tests performed in connection with the present invention (described in more detail in the Examples).

The films made of binary polymer compositions presented herein have advantageous properties in packaging applications, which has been shown in tests performed in connection with the present invention.

Firstly, when oriented, they produce tearing properties for easy opening of packaging.

Secondly, they have considerably better properties in packaging with UV resistance, scratch resistance and puncture resistance. In some applications, it may be of high importance that a packaging has good properties regarding UV ageing (yellowing). Further, in some applications, the materials need high scratch resistance and puncture resistance to protect the packed product. If the package is harmed, it may also not look as appealing to the consumer. Thus, the above-mentioned properites are very important in many applications. The films made of binary polymer composition can also be made clear and transparent.

Also, the films according to the invention based on binary polymer blends presented herein can be processed with the same film production and thermoforming equipments as used with PET films. This is beneficial, since no large investments in new equipment is needed.

Furthermore, the films made from binary polymer compostions presented herein may have a low environmental impact. This has been shown in tests. Their global warming potential is much lower, and the renewable content is much higher than those of e.g. PET.

One aim of the invention is to achieve an environmentally friendly packaging solution, which could replace traditional plastic materials based on fossil raw-materials. Thus, biopolymers are preferred in the binary polymer composition.

Biopolymers are polymers which are made, either partially or completely, from renewable resources. Another definition of biopolymers are polymers which are biodegradable. It is enough for a biopolymer to fulfil one of these definitions.

Different polymers may have very different values for glass transition temperature (Tg). Glass transition temperatures are commonly determined by DSC measurements (Differential Scanning calorimetry). The Tg of a specific polymer grade depends on the molecular structure and molecular weight, also the chemical cross-linking and the number of polar groups affect the Tg value.

There are polymers with very low Tg values. For example, the following polymers have Tg values of below or close to 0° C. (the Tg values are from literature sources).

TABLE 1
Polymers with low Tg values suitable for the
film according to the present invention

| Polymer | Tg (range) ° C. | |
|---|---|---|
| PPS (polypropylene succinate) | −34 | |
| PBS (polybutylene succinate) | −32 | (to −44) |
| PBSA (polybutylene succinate adipate) | −45 | |
| PBAT (polybutylene adipate terephthalate) | −28 | |
| PBA (polybutylene adipate) | −68 | |
| PCL (polycaprolactone) | −60 | |
| PHA (polyhydroxyalkanoate) | −44 | (to 2) |

| | |
|---|---|
| PHB (polyhydroxybutyrate) | 5 |
| PBSE (polybutylene sebacate) | −59 |

In addition, to the polymers listed in Table 1 polyesters containing azelaic acid, sebacic acid and/or dodecanedioic acid as dicarboxylic acids alone or in combination with terephthalic of furanedicarboxylic acids can be used. These have similar Tg values as the polymers of Table 1.

There are also polymers with high Tg values. For example, the following polymers have high Tg values (the Tg values are from literature sources).

TABLE 2
Polymers with high Tg values suitable for
the film according to the present invention

| Polymer | Tg (range) ° C. |
|---|---|
| PLA (polylactic acid) | 64 |
| CA (cellulose acetate) | 80-130 |
| CAB (cellulose acetate butyrate) | 80-130 |
| CAP (cellulose acetate propionate) | 80-140 |
| PEF (polyethylene furanoate) | 86 |

The invention concerns a film based on a binary polymer composition comprising at least a first polymer and a second polymer, wherein the film is oriented by extruding and stretching the film in at least machine direction (MD). The glass-transition temperature (Tg) of the first polymer is greater than the orientation temperature and the glass-transition temperature (Tg) of the second polymer is lower than the orientation temperature.

The polymers in Table 1 are suitable as the second polymer. In addition, polyesters containing azelaic acid, sebacic acid and/or dodecanedioic acid as dicarboxylic acids alone or in combination with terephthalic of furanedicarboxylic acids can be used. Any combination of these polymers is also possible.

The polymers in Table 2 or any combination of them are suitable as the first polymer.

The polymers in Table 1 and in Table 2 are known to be miscible or semi-miscible. Thus, binary polymer compositions could be formed by a combination of any polymers from Table 1 (and the other listed polymers) and Table 2.

Not bound by any theory, the inventors have attemted to describe the effect of the orientation in binary polymer compositions.

In connection with the present invention, the inventors noticed that the orientation ratio has a considerable effect on the tearing properties of the film made of a binary polymer blend.

The cast flat film is extruded with an orientation ratio of 1.0 (i.e. no orientation), as no external force is applied to create orientation of polymers in the film. This binary polymer film is not very easy to tear, and with a cut made to the film the film may tear to any direction.

The inventors noticed that when force is applied to the film after extrusion, orientation of polymers in molecular level and/or domain level occurs. After applying mono-directional orientation force in machine direction (MD) to the film creating an orientation ratio of for example 1.7 the tear mechanism of the binary film changes dramatically. The orientation ratio may also be lower or higher, and the suitable orientation ratio depends on the selected first and second polymers. The mono-directionally oriented film does not tear essentially to machine direction (MD), but it is possible to tear the film only to transverse direction (TD). With a small cut or the like made to either MD or TD direction, the ripping always follows the TD direction. In this disclosure “transverse direction (TD)” is defined as opposite to the machine direction, by which direction the orientation of the film has been made. Similarly, “longitudinal direction” or “machine direction (MD)” is defined as in the machine direction, in which direction the orientation of the film has been made.

According to one embodiment, the film is a bi-oriented film, i.e. it is oriented in both machine direction (MD) and in transverse direction (TD).

For known films, in general, mono-directional orientation causes a tear mechanism where, for example, a film with machine direction applied orientation tears clearly in the machine direction (MD) not in the transverse direction (TD). This common behaviour is due to the alignment of polymer domains and molecules. This kind of tear mechanism is observed for example in polypropylene films with mono-directional orientation.

In the case of films according to the invention based on binary polymer compositions, the tear effect caused by the mono-directional orientation is observed with binary polymer compositions comprising miscible or semi-miscible polymers which have sufficiently different glass transition temperatures.

The orientation temperature is selected to be lower than the Tg of the first polymer and higher than the Tg of second polymer. Typically, the Tg difference of the first and the second polymer is at least 40° C., at least 50° C., or at least 60° C. The difference between the Tg temperature and the orientation temperature should typically be 10° C.-30° C. This way the second polymer is in its rubbery amorphous state and its polymer chains and domains are oriented by the external force. Simultaneously, the orientation temperature is lower than the Tg of first polymer which thus remains in its glassy state. As polymer is its glassy state, orientation force cannot change its orientation, and the polymer blend will be oriented only from its part which is dominated by the second polymer with a Tg lower than orientation temperature.

According to an embodiment of the invention, the film has an orientation level of at least 1.1. Typically, the orientation level is between 1.1 and 10.0. The orientation level may also be for example at least 1.2, or at least 1.3, or at least 1.4, or at least 1.5, or at least 1.6, or at least 1.7. Typically, it is below 10.0, or below 9.0, or below 8.0, or below 7.0. The most suitable orientation level depends on which polymers are selected for the binary polymer blend. The most suitable orientation level may also vary depending on the intended end use.

According to an embodiment of the invention, the film is a mono-directionally oriented film, which is oriented in machine direction (MD).

According to an embodiment of the invention, the first polymer is selected from the group consisting of PLA (polylactic acid), CA (cellulose acetate), CAB (cellulose acetate butyrate), CAP (cellulose acetate propionate) and PEF (polyethylene furanoate), and any combination of these, and the second polymer is selected from the group consisting of PPS (polypropylene succinate), PBS (polybutylene succinate), PBSA (polybutylene succinate adipate), PBAT (polybutylene adipate terephthalate), PBA (polybutylene adipate), PCL (polycaprolactone), PHA (polyhydroxyalkanoate), PHB (polyhydroxybutyrate), PBSE (polybutylene sebacate), polyesters containing azelaic acid, sebacic acid and/or dodecanedioic acid as dicarboxylic acids alone or in combination with terephthalic and/or furanedicarboxylic acids, and any combination of these.

According to an embodiment of the invention, the first polymer is selected from the group consisting of cellulose acetate propionate (CAP) and cellulose acetate butyrate (CAB), and that the second polymer is selected from the group consisting of polybutylene succinate (PBS) and polypropylene succinate (PPS), or any combination of these. According to one embodiment related to this selection of polymers, the film comprising the above polymers has an orientation level between 1.1 and 2.5. Typically, the orientation level is between 1.2 and 2.1, or between 1.3 and 2.0. Preferably, the orientation level of this specific film embodiment is between 1.5 and 2.0. These orientation levels have been shown to be especially suitable for films based on these defined blends.

According to an embodiment of the invention, the second polymer is polybutylene succinate (PBS).

According to an embodiment of the invention, the first polymer is cellulose acetate propionate (CAP).

According to tests perfomed in connection with the present invention, and shown in the examples, the desired effect i.e. the modified tearibility can be achieved with a blend comprising PBS as the second polymer and CAP as the first polymer.

According to an embodiment of the invention, the binary polymer composition comprises the first polymer in an amount of 5 to 95 weight-%, and the second polymer in an amount of 95 to 5 weight-%, based on the total weight of the polymer composition.

According to an embodiment of the invention, the total amount of the first polymer and said second polymer it at least 80 wt. % based on the total weight of the binary polymer composition. Typically, the amount is at least 90 wt. %, or at least 95 wt. %, based on the total weight of the binary polymer composition the rest being other polymers and/or additives such as softeners, pigments, stabilizers or other additives for use in plastic compositions.

According to an embodiment of the invention, the binary polymer composition comprises the first polymer in an amount of 55 to 80 weight-%, preferably 60 to 75 weight-%, more preferably 65 to 75 weight-%, and said second polymer in an amount of 20 to 40 weight-%, preferably 25 to 35 weight-%, based on the total weight of the binary polymer composition.

According to one very specific embodiment, the binary polymer composition comprises CAP in an amount of 5 to 95 weight-%, preferably 10 to 90 weight-%, more preferably 20 to 80 weight-%, and PBS in an amount of 5 to 95 weight-%, preferably 10 to 90 weight-%, more preferably 20 to 80 weight-%, based on the total weight of the binary polymer composition. According to one very specific embodiment, the total amount of CAP and PBS is at least 85 wt. %, preferably at least 90 wt. %, based on the total weight of the binary polymer composition the rest being other polymers and/or additives such as softeners, pigments, stabilizers and/or other additives for use in plastic compositions.

According to one embodiment, the second polymer is PBS and the PBS has a number average molar mass in the range of 30,000 to 100,000 Da. Typically, 50,000 to 80,000 Da, or more typically 60,000 to 70,000 Da.

According to one very specific embodiment, the first polymer is CAP and the second polymer is PBS. Further, the binary polymer composition then comprises CAP in an amount of 55 to 80 weight-%. Typically, in an amount of 60 to 75 weight-%, or 65 to 75 weight-%. The composition then comprises PBS in an amount of 20 to 40 weight-%. Typically, 25 to 40 weight-%, or 25 to 35 weight-%. Weight-%:s are based on the total weight of the composition. Optionally, the mixture comprises at least one additive such as softeners, pigments, stabilizers and/or other additives for use in plastic compositions.

According to one very specific embodiment, the binary polymer composition consists of CAP in an amount of 60 to 80 weight-%, typically 60 to 75 weight-%, or 65 to 75 weight-%, and PBS in an amount of 20 to 40 weight-%, typically 25 to 40 weight-% or 25 to 35 weight-%, based on the total weight of the composition, and optionally at least one additive, such as softeners, pigments, dyes, stabilizers and/or other additives for use in plastic compositions, and/or other thermoplastic polymers compatible with CAP and PBS.

According to one embodiment, the binary polymer composition comprises at least one softener. For example, triethyl citrate (TEC).

According to one specific embodiment, the CAP has a number average molar mass of 30,000 to 110,000 Da; preferably 50,000 to 100,000 Da; more preferably 65,000 to 95,000 Da.

According to one specific embodiment, CAP has an acetyl content of 0.8 to 2.0 wt. %, more preferably 1.0 to 1.5 wt. %, and/or a propionyl content of 30 to 51 wt. %, more preferably 40 to 50 wt. %, and/or a hydroxyl content of 1.0 to 2.5 wt. %, more preferably 1.5 to 2.0 wt. %.

Suitably, if CAP is used, the number average molar mass of the CAP polymer is above 20,000 Da. According to one embodiment, the number average molar mass is between 30,000 to 110,000 Da, typically between 50,000 to 100,000 Da, or 65,000 to 95,000 Da. The number average molar mass may be between 85,000 and 95,000 Da, or between 85,000 and 91,000 Da, for example 90,000 Da, 91,000 Da or 92,000 Da. A number average molar mass within the above defined ranges may provide a resilient material with mechanical properties that withstand processing.

All number average molar mass measurements performed in connection with the invention were measured with size exclusion chromatography (SEC) using chloroform eluent for the number average molar mass measurements. The SEC measurements were performed in chloroform eluent (0.6 ml/min, T=30° C.) using Styragel HR 4 and 3 columns with a pre-column. The elution curves were detected using Waters 2414 Refractive index detector.

The molar mass distributions (MMD) were calculated against 10×PS (580-3040000 g/mol) standards, using Waters Empower 3 software.

Different grades of cellulose esters, such as cellulose acetate propionate, are commercially available from several suppliers. In the disclosed binary polymer composition, the polymer raw materials affect the properties of the formed mixture. In other words, the combined properties of the polymers need to be evaluated when forming the composition according to the invention. For example, if one of the polymers has a high number average molar mass, such as 90,000 Da or 70,000 Da, it could be suitable to combine this polymer with another polymer having a lower number average molar mass. Al-ternatively, or additionally, a higher amount of softener may be used together with polymers with a high molar mass. The suitable number average molar mass depends on the end use of the composition, i.e. the most suitable cellulose ester grade may be different depending on the intended end use. Cellulose esters may have different grades of substitution. The CAP suitable for the composition of the present invention suitably has an acetyl content of 0.8 to 2.0 wt. %. Typically, 1.0 to 1.5 wt. %, for example 1.3 wt. %. The CAP suitable for the composition of the present invention suitably has a propionyl content of 30 to 51 wt. %. Typically, it may be 40 to 50 wt. %. A very specific example is 48 wt. %. The CAP suitable for the composition of the present invention suitably has hydroxyl content of 1.0 to 2.5 wt. %. Typically, 1.5 to 2.0 wt. %, for example 1.7 wt. %. In addition, the glass transition temperature is suitably 140 to 155° C. Typically, 142 to 152° C., for example 147° C.

According to one embodiment, if PBS is used, the PBS suitable for the composition of the present invention has a number average molar mass in the range of 30,000 to 100,000 Da. Typically, 50,000 to 80,000 Da; or 60,000 to 70,000 Da. The number average molar mass of the PBS may be for example 65,000 to 70,000 Da, such as for example 68,000 Da, 69,000 Da or 70,000 Da.

Melt flow index (or melt flow rate) is a measure to describe ease of flow of the melt of a thermoplastic polymer or plastic. The melt flow index can be used to characterize a polymer or a polymer mixture. For polyolefins, i.e. polyethylene (PE, at 190° C.) and polypropylene (PP, at 230° C.) the MFI is commonly used to indicate order of magnitude for its melt viscosity. In standardized MFI measuring instrument a constant pres-sure generates shear stress which pushes melt plastic through a die. Typically, MFI is inversely proportional to molecular weight. For the homogenious polymer mixture in the solution of the invention the MFI was measured at two temperatures 215 and 240° C. According to one very specific embodiment, the binary polymer composition has a melt flow index of 6 to 8 g/10 min. Suitably, about 7 g/10 min, or 6.9 g/10 min. Measured at: load 2.16 kg, at 215° C., and/or about 26 to 28 g/10 min, 27 g/10 min, or 27.1 g/10 min, load 2.16 kg, at 240° C.

According to one embodiment, the binary polymer composition suitable for the solution according to the invention comprises CAP and PBS in combination with another component, which is selected from the list consisting of a cellulose ester, such as cellulose acetate or cellulose acetate butyrate (CAB), an aliphatic or aliphatic aromatic polyester, such as polybutylene succinate adipate (PBSA) or polybutylene adipate terephthalate (PBAT), a polyhydroxyalkanoate (PHA), such as polyhydroxybutyrate (PHB), polylactic acid (PLA), and polycaprolactone (PCL). According to one embodiment, the homogenous polymer mixture comprises also other similar polymers, which are compatible with CAP and PBS.

The binary polymer composition may also comprise other components, such as additives typically used in plastics. These additives are for example softeners or plasticizers, fillers, aids, pigments, stabilizers or other agents. Typically, the amounts of these additives vary between 0.01 to 10 weight-% based on the weight of the binary polymer composition used in the invention. The amount of one additive may for example be 0.1 to 5 weight-% based on the total weight of the composition.

The present invention also relates to a package comprising the film according to any one of the above described embodiments.

According to an embodiment of the invention, the package comprises a tearing element, where the package has been arranged to tear open in a transverse direction (TD). The transverse direction is opposite to the machine direction in which the film has been oriented.

According to an embodiment of the invention, the package comprises a tearing element which is selected from the group consisting of a perforation, a notch, an extrusion, a fold and a bend, and any combination of these.

Furthermore, the invention relates to a method for manufacturing a film based on a binary polymer composition, wherein the method comprises the following steps:
obtaining a homogenous polymer blend of a binary polymer composition comprising at least a first polymer and a second polymer,
forming said homogenous polymer blend into a film, and
orientating said film by extruding and stretching the film in at least machine direction (MD), and the glass-transition temperature (Tg) of the first polymer is greater than the orientation temperature and the glass-transition temperature (Tg) of the second polymer is lower than the orientation temperature.

The method may be used to obtain a film based on a binary polymer composition according to any one of the embodiments described above.

According to an embodiment of the invention, obtaining the homogenous polymer blend is performed by melt-mixing and the melt-mixing is performed at a temperature above 150° C., or between 180° C. and 300° C., or between 200° C. and 270° C., or between 210° C. and 250° C. Typically, the temperature is between 210° C. and 230° C.

According to an embodiment of the invention, forming said homogenous polymer blend into a film is done by cast film extrusion.

According to an embodiment of the invention, the first polymer is selected from the group consisting of cellulose acetate propionate (CAP) and cellulose acetate butyrate (CAB), and the second polymer is selected from the group consisting of polybutylene succinate (PBS) and polypropylene succinate (PPS), and any combination of these. The binary polymer composition then comprises at least 80 wt. % of the first polymer and the second polymer, based on the total weight of the binary polymer composition.

Yet another aspect of the invention is use of the film according to any one of the embodiments described above for the manufacture of a packaging material. The package material may be selected from for example cling film, shrink film, stretch film, multilayer film, bag film or container liners, films meant for consumer packaging (e.g. packaging film for frozen products, shrink film for transport packaging, food wrap film, packaging bags, or form, fill and seal packaging film), laminating film (e.g. laminating of aluminum or paper used for packaging for example milk or coffee), barrier film (e.g. film acting as an aroma or oxygen barrier used for packaging food, e.g. cold meats and cheese), films for the packaging of medical products, agricultural film (e.g. greenhouse film, crop forcing film, silage film, silage stretch film), extrusion coating applications, bag, box, container, tray, casing, housing or molded 3D-objects, and/or other applications in packaging goods, such as food, medical products or cosmetics.

According to one embodiment, the packaging material is a tearable package, which comprises a tearing element, where the package has been arranged to tear open in a direction which is opposite to the machine direction. The machine direction is the direction according to which the film has been oriented.

By the expression “recycling” or “recycled” should be understood in this specification, unless otherwise stated, the process, or obtained by the process, of reprocessing and reusing a material so that the molecules in the material are obtained back in reuse either as polymers, monomers or smaller chemical building blocks. Recyclability refers to the ability to recycle a material for re-use. Preferably, plastic packaging films and materials should be recyclable with either mechanical recycling or chemical recycling to enable re-use of the molecular material. This is clearly stated in the European Commission reports (Plastics Strategy 2018) as well as in the basic principles of Circular Economy.

Films containing cellulose-based polymers are not known to be recyclable for re-use. Even when the plastic film material can be reprocessed into a new pellet, it is not evident that the resulting pellets are fit for the production for a new film. However, according to some embodiements, oriented films of binary polymer compositions of this disclosure may be recyclable both chemically and mechanically.

“Mechanical recycling” may for example be the process of taking a plastic film roll and feeding it into a shredder, melting it, compounding it into a strand, and then pelletizing the strand. These recycled pellets can then be made into a new film product.

“Chemical recycling” may for example be the process of taking a plastic film roll and processing the material into small chemical components, for instance syngas, the mixture of hydrogen, H₂, and carbon monoxide, CO. These chemical building blocks can then be used directly in the making of new monomers for the new plastic product.

Generally, different parts of the polymers can be recycled in different ways. For example, cellulose derivatives may undergo chemical recycling. Further, many types of organic polymers can be used as feedstocks for chemical recycling. Typically, the outcome of the chemical recycling process is for example syngas, a combination of hydrogen H₂ and carbon monoxide CO gases.

Re-producing the cellulose polymer structure itself as the outcome of chemical recycling is however currently not done. However, the chemicals used in the modification of the cellulose can be produced from chemically recycled feedstocks. For instance, the acetate groups in cellulose acetate, or the propionic ester groups in cellulose acetate propionate can be produced from the chemically recycled feedstocks.

Furthermore, several polymers, such as polyesters, can be used as feedstocks for chemical recycling. The outcomes of their recycling process can vary depending on the process that is being used. Polyesters can be hydrolysed to oligomers, dimers, or monomers. Also, the polymer can be rebuilt by using an esterification process. Polyesters can also be used in thermal chemical recycling processes to produce for instance syngas. This mixture can then be further used to build monomers, or other chemical building blocks. Therefore, polymers like polyesters can be used as feedstock in chemical recycling processes. In addition, polymers like polyesters can be manufactured from the materials which are the outcome of chemical recycling processes.

According to one embodiment, the film comprises chemically recycled content.

According to one embodiment, the film comprises 5 to 80 wt. %, or 20 to 70 wt. %, or 30 to 60 wt. %, or 40 to 50 wt. %, chemically recycled content based on the total weight of the film. The amount may be for example to 80 wt. %, or 30 to 50 wt. % chemically recycled content based on the total weight of the film. The amount of chemically recycled content may also be for example to 80 wt. %, or 50 to 70 wt. %, or 60 to 75 wt. %. Prefereably, the amount of chemically recylcled content is 5 to 40 wt. %.

When it comes to cellulose polymer derivatives, currently, a cellulose polymer derivative cannot be entirely made with chemically recycled content. Typically, the ester moieties in for example cellulose acetate, cellulose acetate propionate or cellulose acetate butyrate can be made from chemically recycled content. In practice, the maximum chemically recycled content in the cellulose derivative therefore is defined by the wt. % of the ester moieties to the total weight of the cellulose polymer derivative. This may typically vary from 20 wt. % to 55 wt. % depending on the ester moiety and the degree of substitution. This is the range for the maximum chemically recycled content in the cellulose polymer derivative as wt. % of the total weight of the cellulose polymer derivative.

For other polymers, such as aliphatic polyesters, the polyester part can be entirely made with chemically recycled feedstocks. Therefore, the maximum chemically recycled content for e.g. polyester is 100 wt. %.

When the films according to this description are produced so that they contain cellulose polymer derivatives as the first polymer and a polyester as second polymer, the chemically recycled content may typically vary from 50 wt. % to upto 80 wt. % if all ester groups in the cellulose-based polymer, such as a cellulose polymer derivative, and the second polymer, such as a polyester, are made from chemically recycled materials.

According to one very specific embodiment, the first polymer is a cellulose-based polymer and chemically recycled content in the film is introduced within the cellulose-based polymer. Prefereably, the polymer is cellulose acetate propionate. The propionate obtained via chemical recycling is more environmentally friendly than the alternative known methods.

According to one embodiment, the film comprises mechanically recycled content. According to one very specific embodiment, when the films according to this description are produced so that they contain cellulose polymer derivatives as the first polymer and a polyester as second polymer, the mechanically recycled content may typically vary from 5 wt. % to upto 100 wt. %. When applying mechanical recycling, the first polymer and the second polymer should be selected such that they are compatible for mechanical recycling.

Thus, according to one embodiment, the film comprises 5 to 100 wt. % mechanically recycled content based on the total weight of the film. The amount of the mechanically recycled content may also be for example 10 to 95 wt. %, or 15 to 90 wt. %, or 20 to 85 wt. %, or to 80 wt. %, or 30 to 75 wt. %. The mechanically recycled films have shown to show a good enough puncture resistance, which make them suitable for packaging applications.

According to one embodiment, the film comprises both mechanically and chemically recycled content.

The solution according to the present invention has several advantages. The most important are:
Providing a film with new properties, which enable easily opened packages for various applications.
In addition, the material can be made out of food-grade materials, which means that they can be used for packing food/medical products, for which fast and easy opening of the package is important.
Providing an environmentally friendly packaging film, manufactured from biopolymers, and which is a high-quality material suitable for replacing conventional packaging films manufactured from fosil based raw-materials.
Providing environmentally friendly film alternatives that may be recycled with chemical and/or mechanical plastics recycling methods and which may contain recycled content.

### EXAMPLES

Reference will now be made in detail to various embodiments, an example of which is illustrated in the accompanying drawing.

The description below discloses some embodiments in such a detail that a person skilled in the art is able to utilize the embodiments based on the disclosure. Not all steps or features of the embodiments are discussed in detail, as many of the steps or features will be obvious for the person skilled in the art based on this specification.

For reasons of simplicity, item numbers will be maintained in the following exemplary embodiments in the case of repeating components.

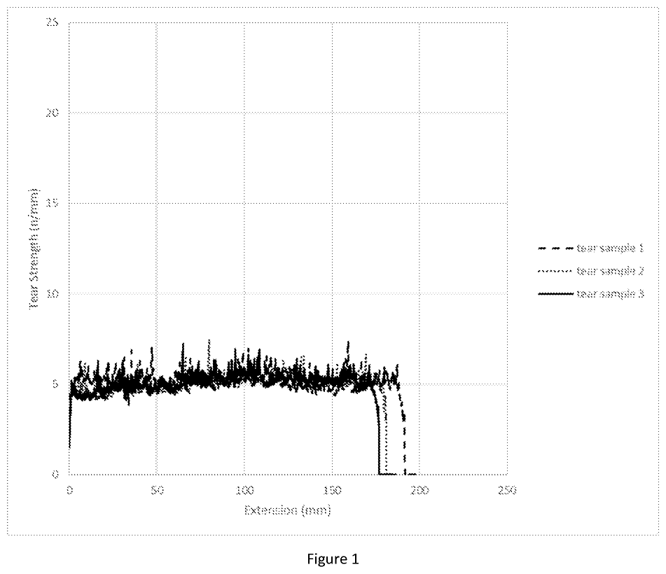

FIG. 1 illustrates Example 3, Film 3 tear test with test sample cut to Transverse Direction (TD). Tear strength is 5.3 N/mm in TD.

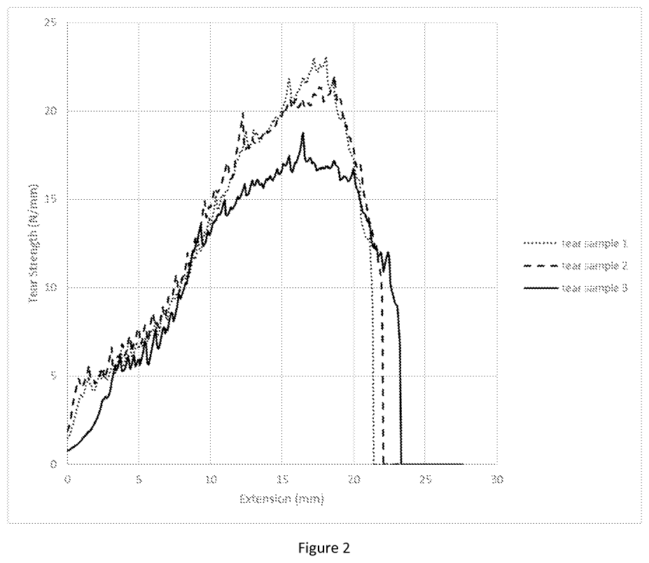

FIG. 2 illustrates Example 3, Film 3 tear test with test sample cut to Machine Direction (MD). Tear strength exceeds 20 N/mm in MD.

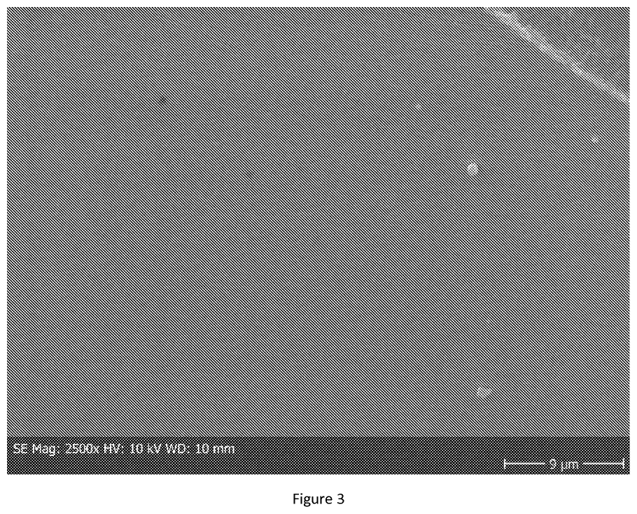

FIG. 3 illustrates Example 5, Scanning electron microscopy of film with orientation degree of 1.0, CAP 72.5% and PBS 27.5% (reference example).

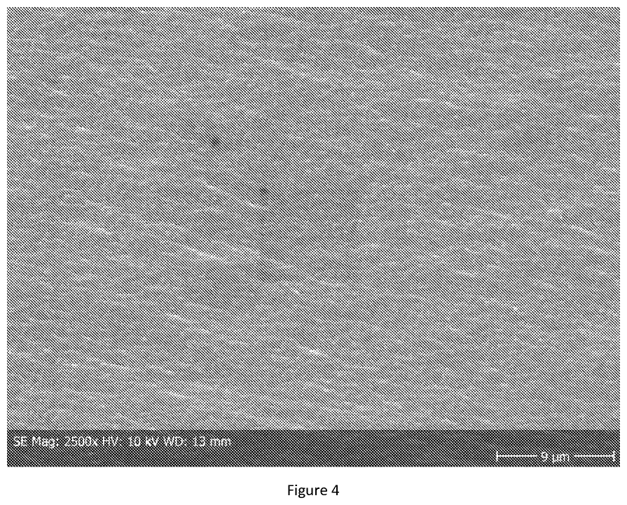

FIG. 4 illustrates Example 5, Scanning electron microscopy of film with orientation degree of 1.5, CAP 72.5% and PBS 27.5%.

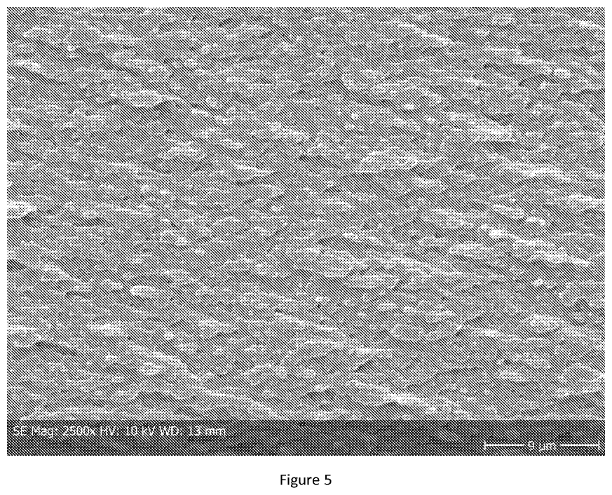

FIG. 5 illustrates Example 5, Scanning electron microscopy of film with orientation degree of 1.9, CAP 72.5% and PBS 27.5%.

The following raw materials have been used in the Examples; properites are identified in Table 3 to Table 5.

TABLE 3
Cellulose acetate propionate (CAP)

| | | | | | Eluent/ |
|---|---|---|---|---|---|
| | | | | | HPSEC |
| Entry | Compound | Mn g/mol | Mw g/mol | PD | system |
| 1 | CAP | 90,000 | 221,000 | 2.5 | Chloro- |
| | | | | | form |

Cellulose acetate propionate had degree of substitution of:
acetyl content 1.2 wt %
propionyl content 48 wt %
hydroxyl content 1.7 wt %

TABLE 4
Polybutylene succinate (PBS)

| | | | | | Eluent/ |
|---|---|---|---|---|---|
| | | | | | HPSEC |
| Entry | Compound | Mn g/mol | Mw g/mol | PD | system |
| 1 | PBS | 76,000 | 215,000 | 2.8 | Chloro- |
| | | | | | form |

The number average molar mass measurements (Mn) were performed with size exclusion chromatography (SEC) using chloroform eluent for the number average molar mass measurements, the samples (Entries), were dis-solved overnight using chloroform (concentration of 1 mg/ml). Samples were filtered (0.45 μm) before the measurement.
The SEC measurements were performed in chloroform eluent (0.6 ml/min, T=30° C.) using Styragel HR 4 and 3 columns with a pre-column. The elution curves were detected using Waters 2414 Refractive index detector. The molar mass distributions (MMD) were calculated against 10×PS (580-3,040,000 g/mol) standards, using Waters Empower 3 software.

TABLE 5
Tg values of used raw materials.

| Entry | Polymer | Tg | |
|---|---|---|---|
| 1 | PBS | −32° | C. |
| 2 | CAP | 140° | C. |

### Example 1: Orientation of a Binary Polymer Compostion on Flat Film Extrusion Line Equipped with MDO Unit

The film line used was a custom-made Extron Mecanor (Finland) flat film extrusion pilot line equipped with MDO (mono directional orientation) unit.

The binary polymer compostion processed on the film extrusion line consisted of 72.5% CAP and 27.5% PBS.

The binary polymer compostion was extruded as flat film with melt pump temperatures of 215-220° C.

The extruded film was treated with the MDO unit with temperatures:

TABLE 6
Temperatures used

| Roll | Temperature | |
|---|---|---|
| Pre-heating | 75-85° | C. |
| Breaking | 75-90° | C. |
| Draw-in | 65-85° | C. |
| Annealing | 65° | C. |

The orientation ratios obtained for the film were between 1.10-1.95.

### Example 2: Mechanical Properties of Mono-Directionally Oriented Film of Binary Polymer Compostion

The following films were made with the flat film extrusion line equipped with MDO (mono directional orientation) unit. Orientation in machine direction (MD).

Film 1: Flat extruded film of thickness 250 μm with orientation ratio of 1.0, consisting of binary polymer blend of 72.5% CAP and 27.5% PBS. (reference example)

Film 2: Flat extruded film of thickness 250 μm with orientation ratio of 1.75 (MDO), consisting of binary polymer composition of 72.5% CAP and 27.5% PBS.

TABLE 7
Measured mechanical properites

| | | Film | Film |
|---|---|---|---|
| Mechanical property (unit) | Direction | 1 | 2 |
| Tear Strength (with tear test | MD | 46 | 69 |
| using trapezoidal test specimen) | TD | 50 | 7.2 |
| (Max force N) | | | |
| Tear Strength (with tear test | MD | 185 | 636 |
| using trapezoidal test specimen) | TD | 210 | 66 |
| (Energy N/mm²) | | | |
| Tensile Strength (N/mm²) | MD | 45 | 89 |
| | TD | 43 | 36 |
| Elongation at break (%) | MD | 94 | 20 |
| | TD | 92 | 149 |

The orientation ratio has a considerable effect on the tearing properties of the film made of binary polymer composition. The cast flat film is extruded with orientation ratio of 1.0, as no external force is applied to create orientation of polymers in the film. This binary film is difficult to tear, and with a cut made to the film the film tears to any direction. When force is applied to the film after extrusion, orientation of polymers in molecular level and/or domain level occurs.

After applying mono-directional orientation force in machine direction (MD) to the film creating an orientation ratio of about 1.7 the tear mechanism of the binary film changes dramatically. The mono-directionally oriented film does not tear to machine direction (MD), but it is possible to tear the film only to transverse direction (TD) (90 degrees compared to the machine direction, i.e. longitudinal direction). With a small cut made to either MD or TD direction, the ripping always follows the TD direction.

### Example 3: Tearing Properties of Mono-Directionally Oriented Film of Binary Polymer Composition

The following film was made with the flat film extrusion line equipped with MDO (mono directional orientation) unit. Orientation in machine direction (MD).

Film 3: Flat extruded film of thickness 250 μm with orientation ratio of 1.70 (MDO), consisting of binary polymer blend of 72.5% CAP and 27.5% PBS.

The tearing properties of Film 3 were studied to MD and TD directions. The test used was the trouser tear method adopted from ISO 6383-1:2015 standard. The test pieces used were 150 mm long and 25 mm wide, with 75 mm cut from one end to the middle of the test piece.

With test pieces prepared with cut to TD the tearing follows the TD direction with even tear strength of 5.3 N/mm (FIG. 1).

With test pieces prepared with cut to MD the tearing the tearing direction turned and propagated in the TD direction as the tear strength exceeds 20 N/mm (FIG. 2).

The direction change in the tear propagation was seen as a non-constant tear force. The force was rising as a function of propagation distance. Before complete break, the tear force declined, thus the maximum force was seen when tear had propagated approximately 70% of its final length.

### Example 4: Orientation of Binary Polymer Composition with Bruckner Karo IV Sheet Orientation Equipment

Extruded flat films with thickness of approximately 300 and 150 μm were oriented with a Bruckner Karo IV sheet orientation equipment. The equipment enables exact control of process parameters. Orientation was performed in one direction which represented the machine direction in the cast film.

TABLE 8
The orientation parameters.

| | | pre- | | initial | | |
|---|---|---|---|---|---|---|
| MD | oven | heating | stretch | film | | |
| orientation | temperature | time | speed | thickness | CAP | PBS |
| ratio | (° C.) | (s) | (%/s) | (μm) | (%) | (%) |
| 1.5 | 80 | 90 | 25 | 320-350 | 72.5 | 27.5 |
| 1.9 | 80 | 90 | 25 | 320-350 | 72.5 | 27.5 |
| 1.5 | 80 | 90 | 25 | 150 | 72.5 | 27.5 |
| 1.9 | 80 | 90 | 25 | 150 | 72.5 | 27.5 |
| 1.7 | 70 | 90 | 25 | 250 | 72.5 | 27.5 |
| 1.9 | 70 | 90 | 25 | 250 | 72.5 | 27.5 |
| 1.5 | [1] | 90 | 25 | 250 | [2] | [3] |
| 1.7 | [1] | 90 | 25 | 250 | [2] | [3] |
| 1.9 | [1] | 90 | 25 | 250 | [2] | [3] |

Values for [1] varied, the values for oven temperature were 70, 75, 80, and 90° C.

Values for [2] varied, the values for CAP content were 70, 75, 80, and 85%

Values for [3] varied, the values for PBS content were 30, 25, 20, and 15%

### Example 5: Scanning Electron Microscopy of Oriented Films

The following films were made with the Bruckner Karo IV sheet orientation equipment

Treatment with liquid nitrogen, Breaking, Studying the break surface with SEM

The film samples were cooled in liquid nitrogen. The samples were broken under liquid nitrogen to give perfect cross-section view into the film. The orientation ratio in MD direction were 1.0, 1.5, 1.7, and 1.9. The blend consisted of 72.5% of CAP and 27.5% of PBS.

The SEM cross-section views for 1.0 orientation ratio did not show any fine structure (FIG. 3). As orientation ratio increase, the fine structure became more visible (FIGS. 4 and 5 with orientation ratio 1.5 and 1.9, respectively). The cross-section SEM graphs indicated that CAP (polymer1) had remained as its non-oriented state, while PBS (polymer2) had been oriented.

### Example 6: Comparing the Films Consisting of Binary Polymer Blend with Commerial PET Film

It is of beneficial that a packaging has good properties regarding UV ageing (yellowing), it should also preferably be scratch resistant and puncture resistant to protect the packed product but also to have an attractive look.

Two Films were Compared:

Film 4: Flat extruded film of thickness 300 μm with orientation ratio of 1.0, consisting of binary polymer blend of 72.5% CAP and 25.5% PBS and additives.

Film 5: Flat extruded commercially available PET film of 300 μm thickness. (Reference example)

UV resistance: Method used was EN ISO 4892-2 Plastics. Methods of exposure to laboratory light sources. Part 2: Xenon-Arc lamps (ISO 4892-2:2013, Method B, Cycle no.2). Equipment used was Q-Sun Xe-3-HS, TLO5007. Samples were taken after 50 h, 100 h, 200 h and 500 h. Coloring was measured from all samples. Colour changes are measured with Conica Minolta Spectrophotometer CM-2500.

TABLE 9
UV resistance

| | | Total change in colour ΔE |
|---|---|---|
| Entry | Film | after 500 hours |
| 1 | Film 4 | 0.54 |
| 2 | Film 5 | 1.04 |

From Table 9 it can be seen that the UV resistance of Film 4 is clearly better than that of Film 5. Film 4 will therefore have less yellowing effect when used in packaging applications.

The scratch resistance was measured using the Erichsen pencil test. Different forces (N) are applied on the film and the smallest force leaving a visible scratch is reported.

TABLE 10
Scratch resistance

| Entry | Film | Scratch resistance (N) |
|---|---|---|
| 1 | Film 4 | 4.5 |
| 2 | Film 5 | 4.0 |

From Table 10 it can be seen that the scratch resistance of Film 4 is clearly better than that of Film 5. Film 4 will therefore have less scratch marks in packaging applications and the packaging will look more attractive.

The puncture resistance was measured according to the standard of EN 14477.

Film 6: Flat extruded film of thickness 150 μm with orientation ratio of 1.0, consisting of binary polymer blend of 70.0% CAP and 30.0% PBS.

Film 7: Flat extruded commercially available PET film of 150 μm thickness. (Reference example)

TABLE 11
Puncture resistance

| Entry | Film | Puncture resistance (N) |
|---|---|---|
| 1 | Film 6 | 17.5 |
| 2 | Film 7 | 15.4 |

From Table 11 it can be seen that the puncture resistance of Film 6 is clearly better than that of Film 7. Film 6 is therefore better suited for packaging of for example sharp items than Film 7.

### Example 7: Comparing the Environmental Impacts of Materials Consisting of Binary Polymer Blend with Commerial PET Material

It is also important that packaging is sustainable and environmentally friendly.

The LCA study of material consisting of binary polymer blend of 70.0% CAP and 30.0% PBS was conducted. This was compared with LCA (Life Cycle Assesment) studies of commercially available PET materials. The global warming potential is shown in the Table 12.

TABLE 12
Global warming potential

| | | Global warming potential, |
|---|---|---|
| | | cradle-to-gate value Kg |
| | | CO₂/Kg granulate material |
| Entry | Material | (including carbon uptake) |
| 1 | Binary blend of 70.0% | −0.08 |
| | CAP and 30.0% PBS | |
| 2 | Commercial PET | 2.92 |
| | (reference example) | |

It is clear, that the global warming potential of the binary blend consisting of 70.0% CAP and 30.0% PBS has much better environmental impact than that of PET, as PET releases 2.92 Kg CO2/Kg PET granulate but the binary blend is in fact carbon negative.

Furthermore, the typical renewable content of the binary blend of 70.0% CAP and 30.0% PBS may be between 40-100% (depending on the raw materials used). The renewable content for commercial PET grades is 0-25% as the terephthalate monomer is not currently produced from renewable raw materials for economical reasons.

### Example 8: Production of Recycled Film

Mixed film waste containing a film of binary polymer composition (containing CAP 65-80% and PBS 20-35%) with additives was fed into a shredder, then melted and further extruded into a strand and pelletized.

The recycled granulate obtained thereby was clear and transparent. This recycled granulate was made into a new film product with a cast film extrusion line. The film obtained was clear and transparent and films with a thickness from 20 μm to 300 μm were successfully prepared. No holes were detected in the recycled films indicating good recyclability and extruding properties for the recycled blends.

The recycled film had excellent puncture resistance as shown in Table 13.

TABLE 13
Puncture resistance.

| | | |
|---|---|---|
| Sample Film 100% | | |
| mechanically | Puncture | |
| recycled content | strength (mJ) | Force (N) |

| | | | |
|---|---|---|---|
| 20 | μm | 0.85 ± 0.18 | 0.98 ± 0.15 |
| 50 | μm | 1.99 ± 0.35 | 2.13 ± 0.26 |
| 70 | μm | 3.89 ± 0.26 | 3.96 ± 0.20 |
| 250 | μm | 13.0 ± 1.12 | 14.5 ± 0.67 |

The recycled blend can be mixed with virgin blend of binary polymer composition. The fraction of mechanically recycled content can vary for example from 5 wt. % to 100 wt. % of the film. The recycled blend can be mixed with virgin blend of binary polymer composition.

### Example 9: NIR Separation of the Film of BiNary Polymer Composition

Film made with CAP 70% and PBS 30% with additives was thermoformed into clamshell packaging. These packaging items were analysed for their NIR spectrum for plastic waste sorting.

The samples showed a clearly identifiable spectral curve and could be identified and sorted in a plastics waste sorting system.

### Example 10: Film of Binary Polymer Composition with Chemically Recycled Content

A cellulose ester polymer and/or a polyester polymer suitable, or other polymer, for the oriented film of binary polymer composition can contain chemically recycled content.

The ester moieties in the cellulose-based polymers, such as CAP and CAB, can be partly or entirely made with chemically recycled feedstocks.

Also, the other polymers used in the blends such as PBS can be partly or entirely made with chemically recycled molecules. The fraction of chemically recyled content can vary for example from 10 wt. % to 80 wt. % of the film.

The examples show that films made of binary blends presented herein have clearly better properties in packaging applications than PET films.

Firstly, when oriented, they produce tearing properties for easy opening of packaging.

Secondly, they have considerably better properties in packaging with UV resistance, scratch resistance and puncture resistance.

Also, these films made of binary blends presented herein can be processed with the same film production and thermoforming equipments as used with PET films.

Furthermore, the films made from binary blends presented herein have much improved environmental impacts than PET films. Their global warming potential is much lower, and the renewable content is much higher than those of PET.

It is obvious to a person skilled in the art that with the advancement of technology, the basic idea may be implemented in various ways. The embodiments are thus not limited to the examples described above; instead they may vary within the scope of the claims.

The embodiments described hereinbefore may be used in any combination with each other. Several of the embodiments may be combined together to form a further embodiment. A product, a system, a method, or a use, disclosed herein, may comprise at least one of the embodiments described hereinbefore. It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items. The term “comprising” is used in this specification to mean including the feature(s) or act(s) followed thereafter, without excluding the presence of one or more additional features or acts.

1. A film based on a binary polymer composition comprising at least a first polymer and a second polymer, characterized in that said film is oriented by extruding and stretching the film in at least machine direction (MD), and that the glass-transition temperature (Tg) of the first polymer is greater than the orientation temperature and the glass-transition temperature (Tg) of the second polymer is lower than the orientation temperature.

2. The film according to claim 1, wherein the film has an orientation level of at least 1.1, preferably between 1.1 and 10.0.

3. The film according to claim 1, wherein the film is a mono-directionally oriented film, which is oriented in machine direction (MD).

4. The film according to claim 1, wherein the first polymer is selected from the group consisting of PLA (polylactic acid), CA (cellulose acetate), CAB (cellulose acetate butyrate), CAP (cellulose acetate propionate) and PEF (polyethylene furanoate), and any combination of these, and that
the second polymer is selected from the group consisting of PPS (polypropylene succinate), PBS (polybutylene succinate), PB SA (polybutylene succinate adipate), PBAT (polybutylene adipate terephthalate), PBA (polybutylene adipate), PCL (polycaprolactone), PHA (polyhydroxyalkanoate), PHB (polyhydroxybutyrate), PBSE (polybutylene sebacate), polyesters containing azelaic acid, sebacic acid and/or dodecanedioic acid as dicarboxylic acids alone or in combination with terephthalic and/or furanedicarboxylic acids, and any combination of these.

5. The film according to claim 1, wherein the first polymer is selected from the group consisting of cellulose acetate propionate (CAP) and cellulose acetate butyrate (CAB), and that the second polymer is selected from the group consisting of polybutylene succinate (PBS), and polypropylene succinate (PPS), and any combination of these.

6. The film according to claim 5, wherein the film has an orientation level between 1.1 and 2.5, preferably 1.5 and 2.0.

7. The film according to claim 1, wherein said second polymer is polybutylene succinate (PBS).

8. The film according to claim 1, wherein the first polymer is cellulose acetate propionate (CAP).

9. The film according to claim 1, wherein said binary polymer composition comprises
said first polymer in an amount of 5 to 95 weight-%, and
said second polymer in an amount of 95 to 5 weight-% based on the total weight of the polymer composition.

10. The film according to claim 1, wherein the total amount of said first polymer and said second polymer it at least 80 wt. %, or at least 90 wt. %, or at least 95 wt. %, based on the total weight of the binary polymer composition the rest being other polymers and/or additives such as softeners, pigments, stabilizers or other additives for use in plastic compositions.

11. The film according to claim 1, wherein said binary polymer composition comprises the first polymer in an amount of 55 to 80 weight-%, or 60 to 75 weight-%, or 65 to 75 weight-%, and said second polymer in an amount of 20 to 45 weigh-%, or 25 to 40 weight-%, or 25 to 35 weight-%.

12. The film according to claim 1, wherein said film comprises chemically recycled content.

13. The film according to claim 1, wherein the film comprises 5 to 80 wt. %, or 20 to 70 wt. %, or 30 to 60 wt. %, or 40 to 50 wt. %, or 5 to 40 wt. % chemically recycled content based on the total weight of the film.

14. The film according to claim 12, wherein the first polymer is a cellulose-based polymer and chemically recycled content is introduced within the cellulose-based polymer, preferably cellulose acetate propionate.

15. The film according to claim 1, wherein said film comprises mechanically recycled content.

16. The film according to claim 15, wherein said film comprises 5 to 100 wt. % mechanically recycled content based on the total weight of the film.

17. The film according to claim 1, wherein the film comprises both mechanically and chemically recycled content.

18. A package comprising the film according to claim 1.

19. The package according to claim 18, further comprising a tearing element, where the package has been arranged to tear open in transverse direction (TD).

20. The package according to claim 19, wherein the tearing element is selected from the group consisting of a perforation, a notch, an extrusion, a fold and a bend, and any combination of these.

21. A method for manufacturing a film based on a binary polymer composition, the method comprising the following steps:
obtaining a homogenous polymer blend of a binary polymer composition comprising at least a first polymer and a second polymer,
forming said homogenous polymer blend into a film, and
orientating said film by extruding and stretching the film in at least machine direction (MD),
wherein the glass-transition temperature (Tg) of the first polymer is greater than the orientation temperature and the glass-transition temperature (Tg) of the second polymer is lower than the orientation temperature.

22. The method according to claim 21, wherein obtaining the homogenous polymer blend is performed by melt-mixing and the melt-mixing is performed at a temperature above 150° C., or between 180° C. and 300° C., or between 200° C. and 270° C., or between 210° C. and 250° C., or between 210° C. and 230° C.

23. The method according to claim 21, wherein said formed film is the film according to claim 1.

24. The method according to claim 21, wherein the first polymer is selected from the group consisting of cellulose acetate propionate (CAP) and cellulose acetate butyrate (CAB), and the second polymer is selected from the group consisting of polybutylene succinate (PBS), and polypropylene succinate (PPS), and any combination of these, and
that the binary polymer composition comprises at least 80 wt. % of said first polymer and said second polymer, based on the total weight of the binary polymer composition.

25. The method according to claim 21, wherein forming said homogenous polymer blend into a film is done by cast film extrusion.

26-27. (canceled)
